(19) United States
(12) Patent Application Publication
(10) Pub. No.: US 2024/0414513 A1
(43) Pub. Date: Dec. 12, 2024

(54) USER-TO-USER RELAY DISCOVERY AND SELECTION

(71) Applicant: QUALCOMM Incorporated, San Diego, CA (US)

(72) Inventors: Karthika PALADUGU, Hyderabad (IN); Hong CHENG, Basking Ridge, NJ (US); Gene Wesley MARSH, San Diego, CA (US); Peng CHENG, Beijing (CN)

(21) Appl. No.: 18/699,872

(22) PCT Filed: Dec. 13, 2021
(86) PCT No.: PCT/CN2021/137357

§ 371 Date: Apr. 9, 2024

(51) Int. Cl. H04W 8/00; H04B 17/318; H04W 76/14; H04W 92/18

(52) U.S. Cl. CPC H04W 8/005; H04B 17/328; H04W 76/14; H04W 92/18

(57) ABSTRACT

Methods, apparatuses, and computer-readable medium are provided. An example method may include transmitting, to one or more UEs including a second UE, a sidelink discovery message for a communication with a third UE. The example method may further include receiving, from the one or more UEs, a sidelink discovery response including information about a path with the third UE. The example method may further include establishing a sidelink connection with the second UE to relay the communication from the first UE to the third UE based, at least in part, on the information about the path between the second UE and the third UE.

### TECHNICAL FIELD

The present disclosure relates generally to communication systems, and more particularly, to wireless communication systems with user to user (U2U) relay.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first user equipment (UE) are provided. The apparatus may include a memory and at least one processor coupled to the memory. The memory and the at least one processor coupled to the memory may be configured to transmit, to one or more UEs including a second UE, a sidelink discovery message for a communication with a third UE. The memory and the at least one processor coupled to the memory may be further configured to receive, from the one or more UEs, a sidelink discovery response including information about a path with the third UE. The memory and the at least one processor coupled to the memory may be further configured to establish a sidelink connection with the second UE to relay the communication from the first UE to the third UE based, at least in part, on the information about the path between the second UE and the third UE.

In another aspect of the disclosure, a method, a computer-readable medium, and an apparatus at a second UE are provided. The apparatus may include a memory and at least one processor coupled to the memory. The memory and the at least one processor coupled to the memory may be configured to receive, from a first UE or a fourth UE, a sidelink discovery message for a communication with a third UE, the sidelink discovery message including a relay service code (RSC). The memory and the at least one processor coupled to the memory may be further configured to transmit, to the first UE or the fourth UE, a sidelink discovery response including information about a path with the third UE.

In another aspect of the disclosure, a method, a computer-readable medium, and an apparatus at a third UE are provided. The apparatus may include a memory and at least one processor coupled to the memory. The memory and the at least one processor coupled to the memory may be configured to receive, from a second UE, a sidelink discovery message for a communication with a first UE. The memory and the at least one processor coupled to the memory may be further configured to transmit, to the second UE, a sidelink discovery response including information about a path with the second UE. The memory and the at least one processor coupled to the memory may be further configured to establish a sidelink connection with the second UE to relay the communication from the first UE to the third UE based, at least in part, on the information about the path between the second UE and the third UE.

In another aspect of the disclosure, a method, a computer-readable medium, and an apparatus at a second UE are provided. The apparatus may include a memory and at least one processor coupled to the memory. The memory and the at least one processor coupled to the memory may be configured to receive, from a first UE or a third UE, one or more discovery announcement messages representing support of user-to-user relaying and reachability, the discovery message including UE information associated with the first UE or the third UE and a set of cost metrics, the set of cost metrics including at least one of a hop count or one or more link quality metrics. The memory and the at least one processor coupled to the memory may be further configured to maintain a UE reachability record representing one or more reachable UEs including the first UE or the third UE based on the one or more discovery messages. The memory and the at least one processor coupled to the memory may be further configured to transmit, to the one or more reachable UEs including the first UE or the third UE, one or more relay UE discovery announcement messages including a RSC and information associated with the one or more reachable UEs. The memory and the at least one processor coupled to the memory may be further configured to receive, from the first UE, a solicitation message for communication with the third UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 illustrates example aspects of a sidelink slot structure.

FIG. 3 is a diagram illustrating an example of wireless devices in an access network.

FIG. 4 is a diagram illustrating example U2U relay.

FIG. 5 is a diagram illustrating control plane and user plane of a source UE and a destination UE for U2U relay.

FIG. 6 is a diagram illustrating communications between UEs for U2U relay.

FIGS. 7A-7E are diagrams illustrating example hops between UEs for U2U relay.

FIG. 8 is a diagram illustrating communications between UEs for U2U relay.

FIG. 9 is a diagram illustrating communications between UEs for U2U relay.

FIG. 10 is a diagram illustrating communications between UEs for U2U relay.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

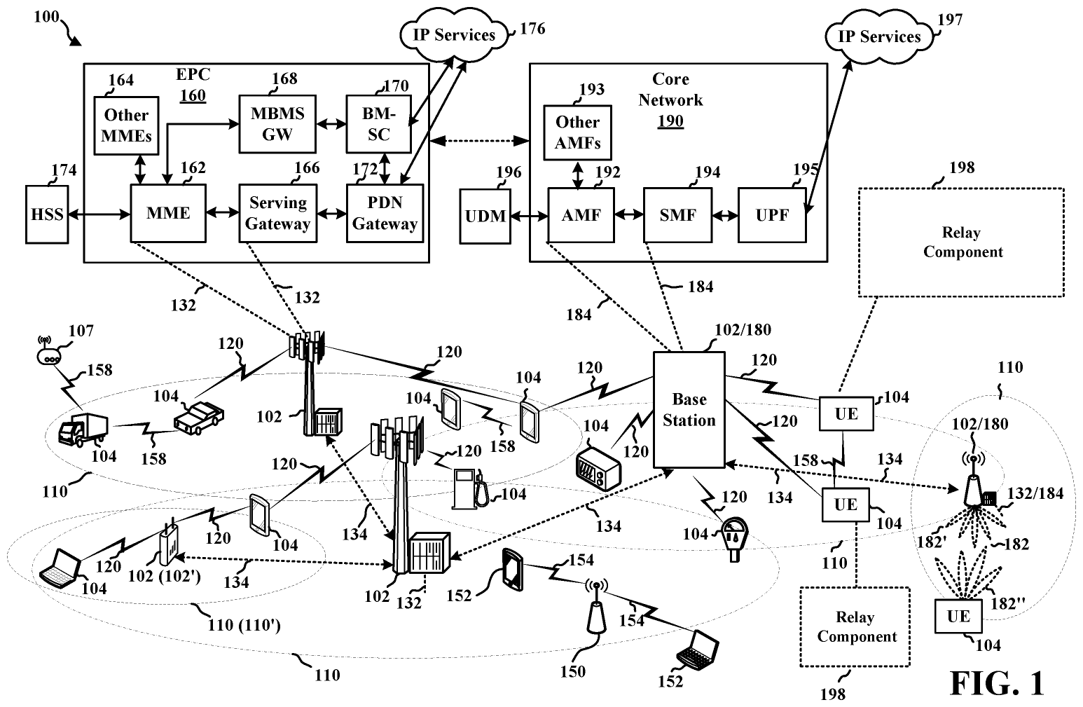

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

A link between a UE 104 and a base station 102 or 180 may be established as an access link, e.g., using a Uu interface. Other communication may be exchanged between wireless devices based on sidelink. For example, some UEs 104 may communicate with each other directly using a device-to-device (D2D) communication link 158. In some examples, the D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

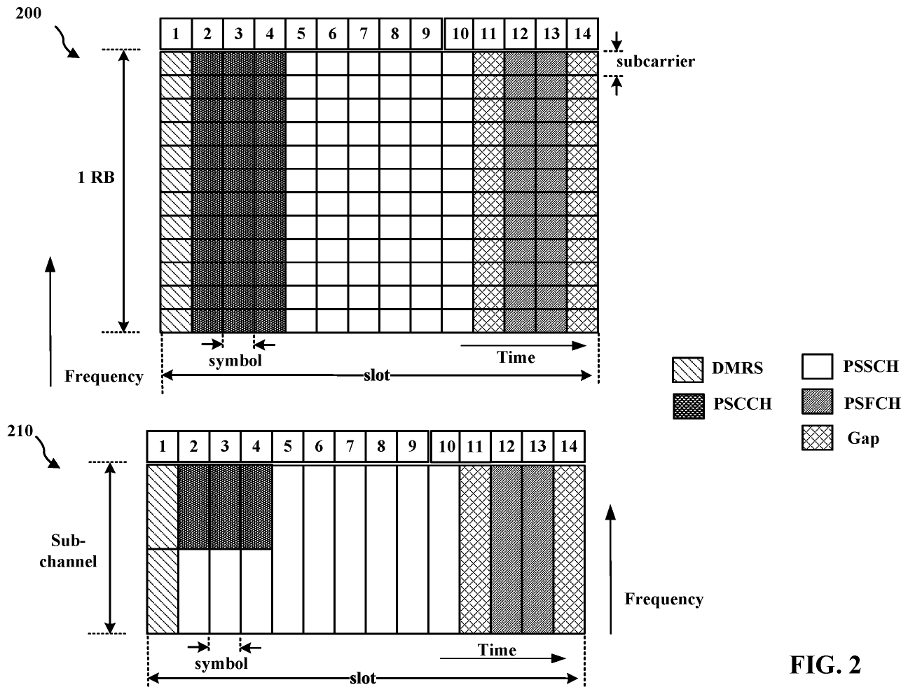

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 2. Although the following description, including the example slot structure of FIG. 2, may provide examples for sidelink communication in connection with 5G NR, the concepts described herein may be applicable to other similar areas, such as LTE, LTE-A, CDMA, GSM, and other wireless technologies.

Referring again to FIG. 1, in certain aspects, a UE 104, or other device communicating based on sidelink, may include a relay component 198. The relay component 198 may be configured to transmit, to one or more UEs including a second UE, a sidelink discovery message for a communication with a third UE. The relay component 198 may be further configured to receive, from the one or more UEs, a sidelink discovery response including information about a path with the third UE. The relay component 198 may be further configured to establish a sidelink connection with the second UE to relay the communication from the first UE to the third UE based, at least in part, on the information about the path between the second UE and the third UE.

In some aspects, the relay component 198 may be further configured to receive, from a first UE or a fourth UE, a sidelink discovery message for a communication with a third UE, the sidelink discovery message including a RSC. The relay component 198 may be further configured to transmit, to the first UE or the fourth UE, a sidelink discovery response including information about a path with the third UE.

In some aspects, the relay component 198 may be further configured to receive, from a second UE, a sidelink discovery message for a communication with a first UE. The relay component 198 may be further configured to transmit, to the second UE, a sidelink discovery response including information about a path with the second UE. The relay component 198 may be further configured to establish a sidelink connection with the second UE to relay the communication from the first UE to the third UE based, at least in part, on the information about the path between the second UE and the third UE.

In some aspects, the relay component 198 may be further configured to receive, from a first UE or a third UE, one or more discovery announcement messages representing support of user-to-user relaying and reachability, the discovery message including UE information associated with the first UE or the third UE and a set of cost metrics, the set of cost metrics including at least one of a hop count or one or more link quality metrics. The relay component 198 may be further configured to maintain a UE reachability record representing one or more reachable UEs including the first UE or the third UE based on the one or more discovery messages. The relay component 198 may be further configured to transmit, to the one or more reachable UEs including the first UE or the third UE, one or more relay UE discovery announcement messages including a RSC and information associated with the one or more reachable UEs. The relay component 198 may be further configured to receive, from the first UE, a solicitation message for communication with the third UE.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming. Similarly, beamforming may be applied for sidelink communication, e.g., between UEs.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although this example is described for the base station 180 and UE 104, the aspects may be similarly applied between a first and second device (e.g., a first and second UE) for sidelink communication.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

FIG. 2 includes diagrams 200 and 210 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may include 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 210 in FIG. 2 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may include control information in PSCCH and some REs may include demodulation RS (DMRS). At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may include the data message described herein. The position of any of the data, DMRS, SCI, feedback, gap symbols, and/or LBT symbols may be different than the example illustrated in FIG. 2. Multiple slots may be aggregated together in some aspects.

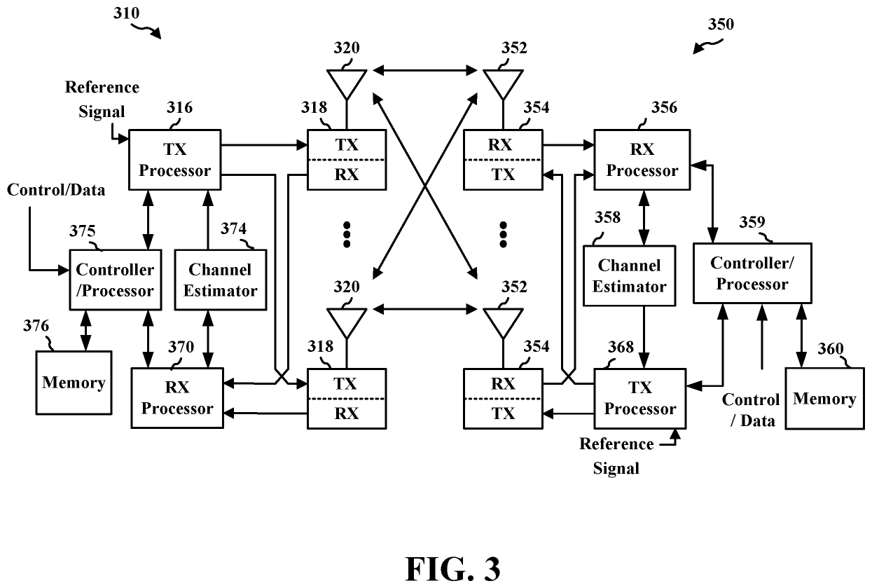

FIG. 3 is a block diagram 300 of a first wireless communication device 310 in communication with a second wireless communication device 350 based on sidelink. In some examples, the devices 310 and 350 may communicate based on V2X or other D2D communication. The communication may be based on sidelink using a PC5 interface. The devices 310 and the 350 may include a UE, an RSU, a base station, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318TX. Each transmitter 318TX may modulate an RF carrier with a respective spatial stream for transmission.

At the device 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an ACK and/or NACK protocol to support HARQ operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The transmission is processed at the device 310 in a manner similar to that described in connection with the receiver function at the device 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 368, the RX processor 356, and the controller/processor 359 may be configured to perform aspects in connection with relay component 198 of FIG. 1.

At least one of the TX processor 316, the RX processor 370, and the controller/processor 375 may be configured to perform aspects in connection with relay component 198 of FIG. 1.

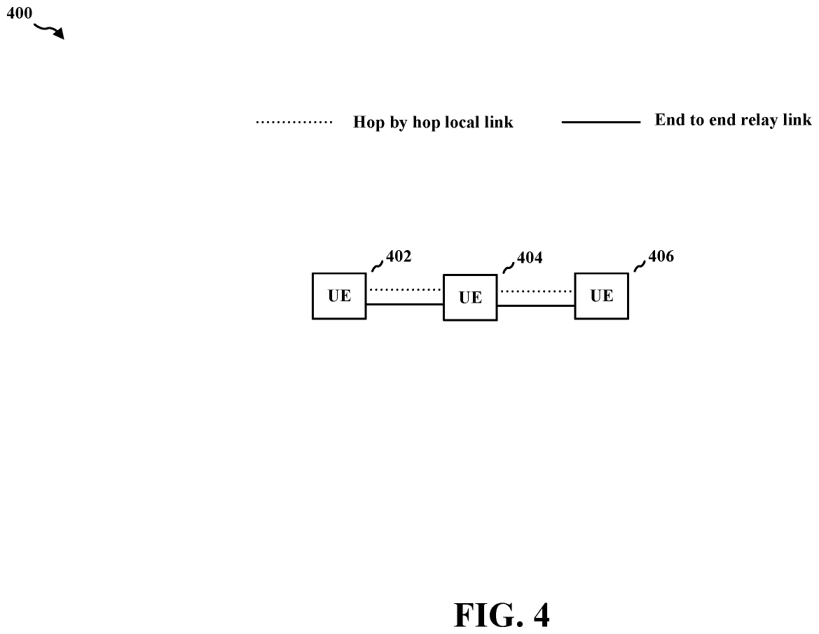

U2U relay, e.g., in which one UE relays communication between two additional UEs, may be used in wireless communication systems for coverage extension. As one example, U2U relay may enable the coverage extension of sidelink transmissions between two sidelink UEs. FIG. 4 is a diagram 400 illustrating example U2U relay. The UE 402 may be a source UE (which may also be referred to as a “S-UE”), the UE 404 may be a relay UE (which may also be referred to as a “R-UE”), and the UE 406 may be a destination UE (which may also be referred to as a “D-UE”). In some aspects, the relay UE 404 may exchange communication in both directions between the UE 402 and the UE 406. FIG. 4 illustrates a hop by hop local link between the UE 402 and UE 404 and between the UE 406 and the UE 404, and an end to end relay link between the UE 402 and the UE 406. A hop to hop local link may be associated with direct communications, e.g., direct sidelink communication, between two UEs and an end to end relay link may be associated with communications, e.g., sidelink communication, that may be relayed to another UE, e.g., via sidelink. The source UE may be a UE that initiates a sidelink relay for communication with a destination UE. The relay UE may be an intermediary UE that relays communications between the source UE and the destination UE. As an example, the relay UE 404 may receive a sidelink message from the UE 402 and may relay the sidelink message to the UE 406. In some aspects, communications may originate from a source UE or a destination after the relay has been set up.

Referring to FIG. 4, in one example, each of the UEs (e.g., the UE 402, the UE 404, and the UE 406) may be in coverage of a network. In another example, each of the UEs (e.g., the UE 402, the UE 404, and the UE 406) may be out of coverage of a network. In another example, at least one UE of the UE 402, the UE 404, and the UE 406 may be out of coverage of a network while at least one UE of the UE 402, the UE 404, and the UE 406 may be in coverage of the network. Each UE of the UE 402, the UE 404, and the UE 406 may be in coverage of a different cell of the network. A base station may operate to support UEs in coverage and corresponding sidelink or downlink/uplink communications.

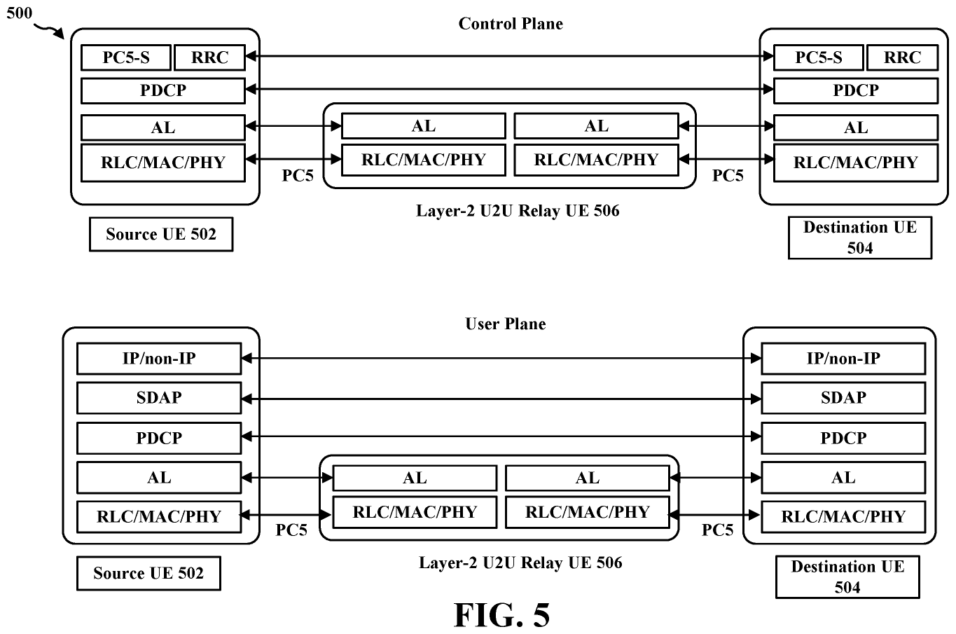

FIG. 5 is a diagram 500 illustrating protocol stacks including a control plane and a user plane of a source UE 502 and a destination UE 504 for U2U relay, e.g., as described in connection with FIG. 4. As illustrated in FIG. 5, referring to the control plane, a sidelink signaling (e.g., PC5-S) and RRC may be exchanged on a control plane between the source UE 502 (e.g., UE 402) and a PC5-S and RRC layer of the destination UE 504 (e.g., the UE 406). A PDCP layer of the source UE 502 may be in communication the PDCP layer of the destination UE 504. In some aspects, one or more application layers (AL) of the source UE 502 may be in communication with one or more AL of a layer 2 (L2) U2U relay UE 506 (e.g., the UE 404), which may be in turn in communication with AL of the destination UE 504. In some aspects, radio link control (RLC), medium access control (MAC), and physical layer (PHY) of the source UE 502 may be in communication with RLC, MAC, and PHY of the L2 U2U relay UE 506, which may be in turn in communication with RLC, MAC, and PHY of the destination UE 504.

Referring to the user plane, a IP/non-IP stack of the source UE 502 may be in communication with a IP/non-IP stack of the destination UE 504. A SDAP of the source UE 502 may be in communication with a SDAP of the destination UE 504. A PDCP of the source UE 502 may be in communication with a PDCP of the destination UE 504. In some aspects, one or more AL of the source UE 502 may be in communication with one or more AL of the L2 U2U relay UE 506, which may be in turn in communication with AL of the destination UE 504. In some aspects, RLC, MAC, and PHY of the source UE 502 may be in communication with RLC, MAC, and PHY of the L2 U2U relay UE 506, which may be in turn in communication with RLC, MAC, and PHY of the destination UE 504.

Aspects provided herein may enable on-demand or proactive U2U relay discovery between UEs. For on-demand U2U relay discovery, a relay service code (RSC) may be may be used for relaying communications. Aspects presented herein provide for RSC-based discovery that may also consider whether a D-UE is reachable via the R-UE, e.g., which may be performed in addition to a consideration of measurements between the S-UE and the R-UE. For on-demand discovery of reachable D-UEs by an R-UE, the S-UE may initiate communication with a D-UE via R-UE and may initiate discovery and selection of the R-UE at that time. For proactive discovery of reachable D-UEs by R-UE, the S-UE/D-UE may periodically advertise their reachability to R-UE. When the S-UE has communication to transmit to a D-UE, the S-UE may query the R-UE for a reachability check with respect to the D-UE. A reachability check may refer to a procedure in which the R-UE attempts to communicate with the D-UE, e.g., transmitting a message to the D-UE and monitoring for a response from the D-UE. Based on the response, or an absence of the response, the R-UE may determine whether the R-UE is able to reach the D-UE, and/or may perform measurements or obtain information about the path between the R-UE and the D-UE. When the S-UE or D-UE select an R-UE, it may be beneficial to choose one or more R-UEs for E2R relaying based on quality information about both hops, e.g., the hop between the S-UE and the one or more R-UEs as well as the hop between the D-UE and the one or more R-UEs. Aspects provided herein enable the consideration of information about a hop between the one or more R-UEs and the D-UE, e.g., based on one or more cost metrics and criteria for relay UE selection to improve the quality of U2U communication.

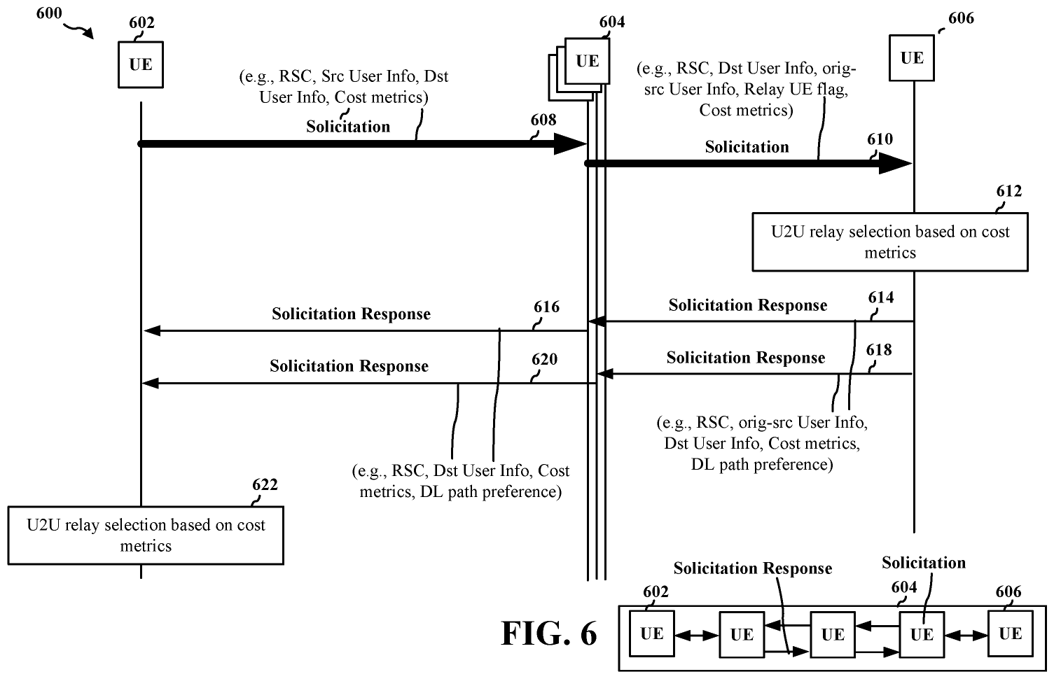

FIG. 6 is a diagram 600 illustrating communications between a source UE 602, one or more relay UEs 604, and a destination UE 606 for U2U relay. As illustrated in FIG. 6, in order to communicate with the destination UE 606, the source UE 602 may transmit a solicitation message 608 to one or more relay UEs 604. In some aspects, the solicitation message 608 may be referred to as a “discovery message”. In some aspects, the solicitation message 608 may include an RSC (e.g., to identify the type of discovery message), source user information associated with the source UE 602, destination user information associated with the destination UE 606, and one or more cost metrics associated with selecting the relay UE. In some aspects, the one or more relay UEs 604 may advertise the RSC in discovery message(s) and the advertised RSC may be included in the solicitation message 608. In some aspects, the source UE 602 may transmit the solicitation message 608 to discover R-UE(s) that can reach the destination UE 606. In some aspects, the solicitation message 608 may be a broadcast or groupcast message to a defined destination L2 identifier (ID) for U2U relay discovery. In some aspects, the source UE 602 may transmit the solicitation message 608 by sending a unicast message to the U2U R-UE(s) with a sidelink discovery reference signal received power (SD-RSRP) higher than a threshold, which may be the one or more UEs 604. In some aspects, the destination L2 ID may be set to the IDs of the one or more UEs 604.

Upon receiving the solicitation message 608 for discovering relay UEs, the one or more relay UEs 604 may transmit information in the solicitation message 608, including the source UE information and the RSC along with a relay UE flag associated with the one or more relay UEs 604 and the cost metrics to a defined destination L2 ID for D-UE(s) discovery in a solicitation message 610. In some aspects, the destination L2 ID can be same as the destination L2 ID for R-UE discovery. In some aspects, the relay UE flag may be used to indicate whether the message is sent from the R-UE or normal UEs. The relay UEs 604 may transmit the solicitation message 610 to relay UEs that may eventually forward the solicitation message 610 to the destination UE 606.

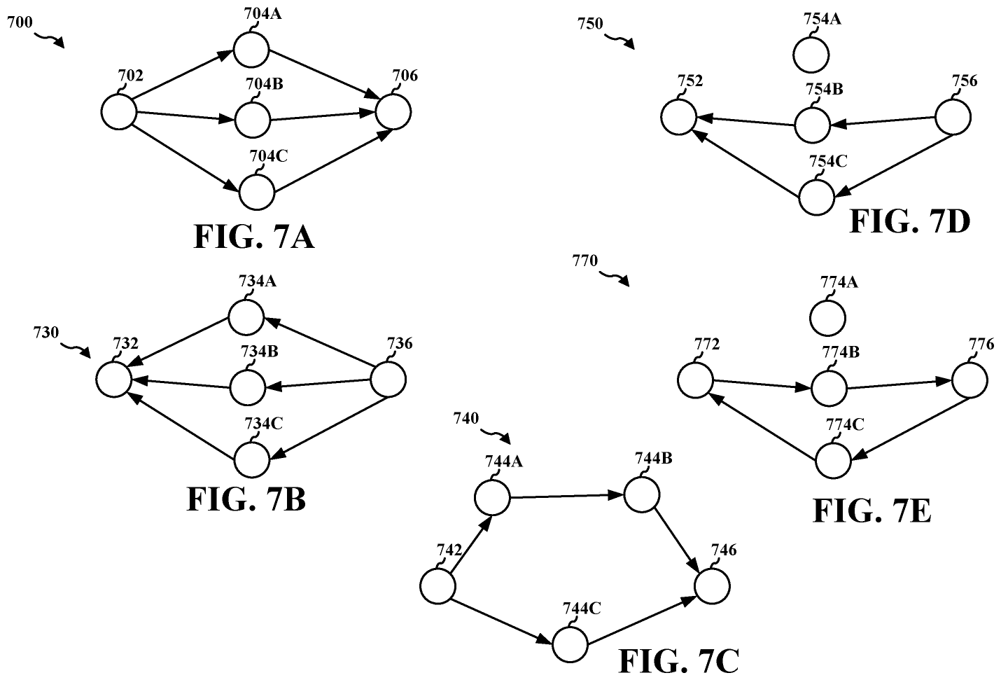

Upon receiving the solicitation message 610, the destination UE 606 may check whether the source user in the source user information associated with the source UE 602 is authorized to connect to the destination UE 606. If the source UE 602 is authorized to connect to the destination UE 606, the destination UE 606 may select one or more R-UE(s) among the one or more relay UEs 604 to connect to the source UE 602 at 612. The destination UE 606 may transmit a solicitation response message 614 to the one or more relay UEs 604, which may in turn transmit the solicitation response message 614 in a solicitation response message 616 to the source UE 602. In some aspects, the solicitation response message 614 may include the RSC, source user information associated with the UE 602, destination user information associated with the UE 606, the cost metrics (which may be described in more details in connection with FIGS. 7A-7E), and a path preference for communications originated from the source UE 602 or a path preference for communications originated from the destination UE 606. In some aspects, the solicitation response message 616 may include the RSC, destination user information associated with the UE 606, the cost metrics such as measurements or information based on the indicated cost metrics (which may be described in more details in connection with FIGS. 7A-7E), and a path preference for communications originated from the source UE 602 or a path preference for communications originated from the destination UE 606. Different solicitation response messages 618 and 620 may be transmitted from the UE 606 to the UE 602 via one or more different UEs in the one or more UEs 604. In case of multi-hop (e.g., multiple relay UEs 604 in between the UE 606 and the UE 602), the intermediary R-UEs forward the received messages to other UEs/R-UEs. In some aspects, as illustrated in FIG. 6, a first UE in the one or more UEs 604 may receive solicitation originated from the source UE 602 and forward the solicitation to a second UE in the one or more UEs 604, which may then forward the solicitation originated from the source UE 602 to a third UE in the one or more UEs 604. The third UE may forward the solicitation originated from the source UE 602 to a destination UE 606. Similarly, the third UE in the one or more UEs 604 may receive solicitation response originated from the destination UE 606 and forward the solicitation response to the second UE in the one or more UEs 604, which may then forward the solicitation response originated from the destination UE 606 to the first UE in the one or more UEs 604. The first UE may forward the solicitation response originated from the destination UE 606 to a source UE 602.

FIGS. 7A-7E are diagrams 700, 730, 740, 750, and 770 illustrating example hops between UEs for U2U relay. Each UE, including S-UE, R-UE, D-UE, such as the UE 602, the one or more UEs 604, and the UE 606, may include cost metrics in messages for establishing U2U relay, such as the solicitation message(s) and solicitation response message(s). In some aspects, cost metrics may include at least one of a hop count and one or more link quality metrics (which may be reported from AS layer to upper layers such as PDCP, RRC, or the like). The one or more link quality metrics may include SD-RSRP of an upstream R-UE, sidelink reference signal received power (SL-RSRP) of an upstream UE, a channel busy ratio (CBR), or other information representing congestion related metrics. On each hop, the R-UE(s) may increment the hop count reported in the cost metrics. On each hop, for the other measured metrics in cost metrics, the R-UEs may include their measured metrics as: add to the list indexed with its own UE ID or Hop ID and aggregate the metrics (average, minimum, or maximum or other operation based on its own metrics, received cost metrics from the downstream neighbor UE, or the like). An upstream R-UE may be a R-UE that forwards messages to another R-UE. An upstream UE may be a UE that transmits/forwards a message to a R-UE. As illustrated in FIG. 7A, the UE 702 may be a S-UE and the UEs 704A, 704B, and 704C may be R-UEs. The UE 706 may be a S-UE. Each of the UEs 704A, 704B, or 704C may increment the hop count from 0 to 1. The cost metrics may include a hop count (which may be 1 across all three paths between the UE 702 and the UE 706), and SD-RSRP/SL-RSRP, CBR, or other metrics associated with the UEs 704A, 704B, or 704C. The cost metrics in FIG. 7A may be associated with a communication from the source UE 702 to the destination UE 706. As illustrated in FIG. 7A, a message, such as a solicitation message, may be transmitted to multiple R-UEs 704A, 704B, and 704C.

As illustrated in FIG. 7B, the UE 732 may be a S-UE and the UEs 734A, 734B, and 734C may be R-UEs. The UE 736 may be a S-UE. Each of the UEs 734A, 734B, or 734C may increment the hop count from 0 to 1. The cost metrics may include a hop count (which may be 1 across all three paths between the UE 732 and the UE 736), and SD-RSRP/SL-RSRP, CBR, or other metrics associated with the UEs 734A, 734B, or 734C. The cost metrics in FIG. 7B may be associated with a communication from the destination UE 736 to the source UE 732.

As illustrated in FIG. 7C, the UE 742 may be a S-UE and the UEs 744A, 744B, and 744C may be R-UEs. The UE 746 may be a S-UE. The cost metrics may include a hop count. The R-UE 744A may report a hop count of 1, the R-UE 744B may increment the hop count to 2 and transmit the hop count to the UE 746, and the UE 744C may report a hop count of 1. Each of the UEs 744A, 744B, or 744C may also include SD-RSRP/SL-RSRP, CBR, or other metrics associated with the UEs 734A, 734B, or 734C in the cost metrics. The cost metrics in FIG. 7B may be associated with a communication from the source UE 742 to the destination UE 736.

Each UE (S-UE, D-UE, R-UE) may perform a R-UE selection procedure. For example, S-UE and D-UE may select the R-UEs based on: 1) UE's own SD-RSRP measurements of the R-UE(s), CBR (Channel Busy Ratio) or other congestion related metrics, or cost metrics received during discovery procedure from the R-UE(s). In some aspects, a D-UE or a S-UE may use at least a minimum hop count or a link quality being above a threshold to select R-UEs. In some aspects, different thresholds may be configured for different metrics such as SD-RSRP, SL-RSRP, or CBR. In some aspects, destination UE may select (e.g., at 612) R-UEs for communications originated from the source UE and may select one or more R-UEs to forward a solicitation response message. In some aspects, D-UE may indicates in the solicitation response message a path preference for whether U2U relaying connection for communications originated from the source UE is preferred via specific R-UE(s) or R-UE(s) preferred by the D-UE for relaying communications originated from the source UE.

As illustrated in FIG. 7D, the destination UE 756 may indicate to the source UE 752 that for communications originated from the source UE 752, UEs 754B and 754C may be preferred and the UE 754A may not be preferred.

In some aspects, the S-UE may selects the R-UE(s) for U2U relay connection setup (e.g., at 622) and may consider the D-UE indicated preference for a path in the solicitation response message. In some aspects, S-UE may select the same R-UE for U2U relay connection for both communications originated from the source UE and communications originated from the destination UE, if one R-UE is selected by D-UE or one R-UE is the best R-UE. In some aspects, S-UE may select different R-UEs for U2U relay connection for communications originated from the source UE and communications originated from the destination UE U2U relay connection. In some aspects, S-UE may select multiple R-UE(s) for U2U relay connection for communications originated from the source UE and communications originated from the destination UE and setup E2E relaying connection via each of the selected R-UE(s). For example, as illustrated in FIG. 7E, the source UE 772 may select the UE 774B for communications originated from the source UE 772. The source UE 772 may select a different UE 774C for communications originated from the destination UE 776. The UE 774A may not be selected.

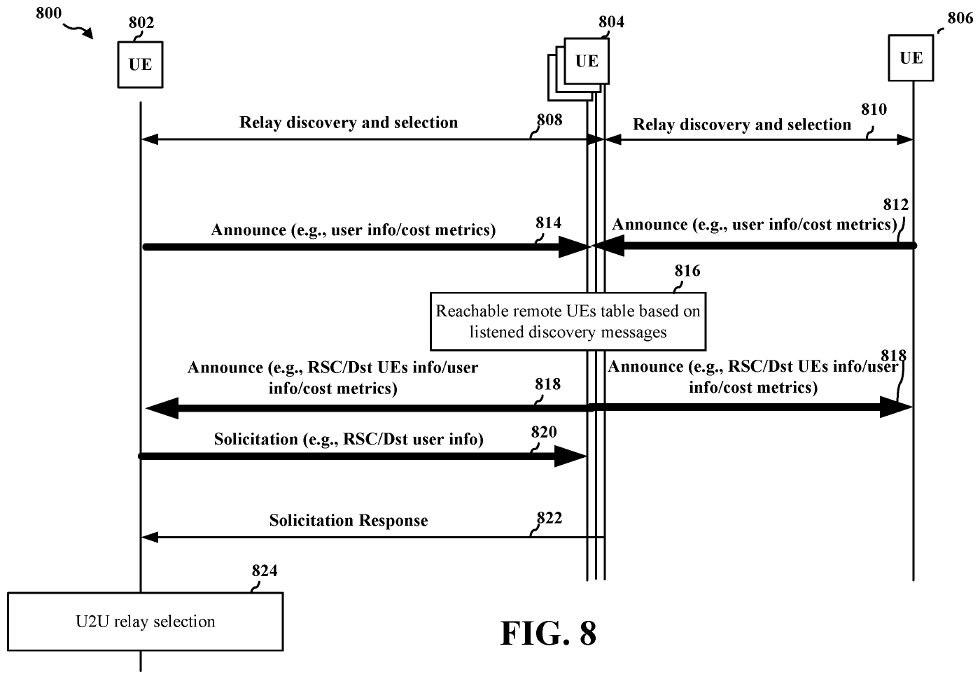

FIG. 8 is a diagram 800 illustrating communications between a source UE 802, one or more relay UEs 804, and a destination UE 806 for U2U relay. As illustrated in FIG. 8, the source UE 802 and the destination UE 806 may perform relay discovery and selection 808 and 810 with the one or more relay UEs 804. The source UE 802 and the destination UE 806 may also advertise support for U2U relaying and reachability to the one or more relay UEs 804 proactively by transmitting announcement 812 and 814. In some aspects, the source UE 802 and the destination UE 806 may advertise the support for U2U relaying and reachability to the one or more relay UEs 804 after using SD-RSRP or other metrics to select the one or more relay UEs 804 to send announcement 812/814 to. In some aspects, the source UE 802 and the destination UE 806 may broadcast the announcement 812 and 814 to all R-UE(s). In some aspects, the source UE 802 and the destination UE 806 may include one or more cost metrics in the announcement 812 and 814. In some aspects, the announcement 812 and 814 may be transmitted periodically.

In some aspects, at 816, the one or more relay UEs 804 may maintains a UE reachability record (e.g., in the form of a table) and may update the record based on the periodic discovery announcements from UEs (S-UE/D-UE such as source UE 802 and the destination UE 806). In some aspects, the one or more relay UEs 804 may include a list of reachable UEs, user information and their corresponding cost metrics in the U2U R-UE discovery announcement message 818. In some aspects, the R-UE discovery announcement message 818 may also include a RSC. In some aspects, source UEs (such as the source UE 802) interested in U2U relaying connection to D-UE (such as the destination UE 806) may send solicitation message 820 and receive solicitation response 822 with cost metrics for the corresponding D-UE (such as the destination UE 806) from one or more R-UE(s) in the one or more relay UEs 804. In some aspects, the S-UE (e.g., the source UE 802) may select (e.g., at 824) one or more R-UE(s) (e.g., of the one or more relay UEs 804) for path(s) for communications originated from the source UE 802 or communications originated from the destination UE 806 based on the cost metrics reported by the source UE 802 and the cost metrics received by the source UE 802 for the link from the source UE 802 to the destination UE 806 and the link from the destination UE 806 to the source UE 802.

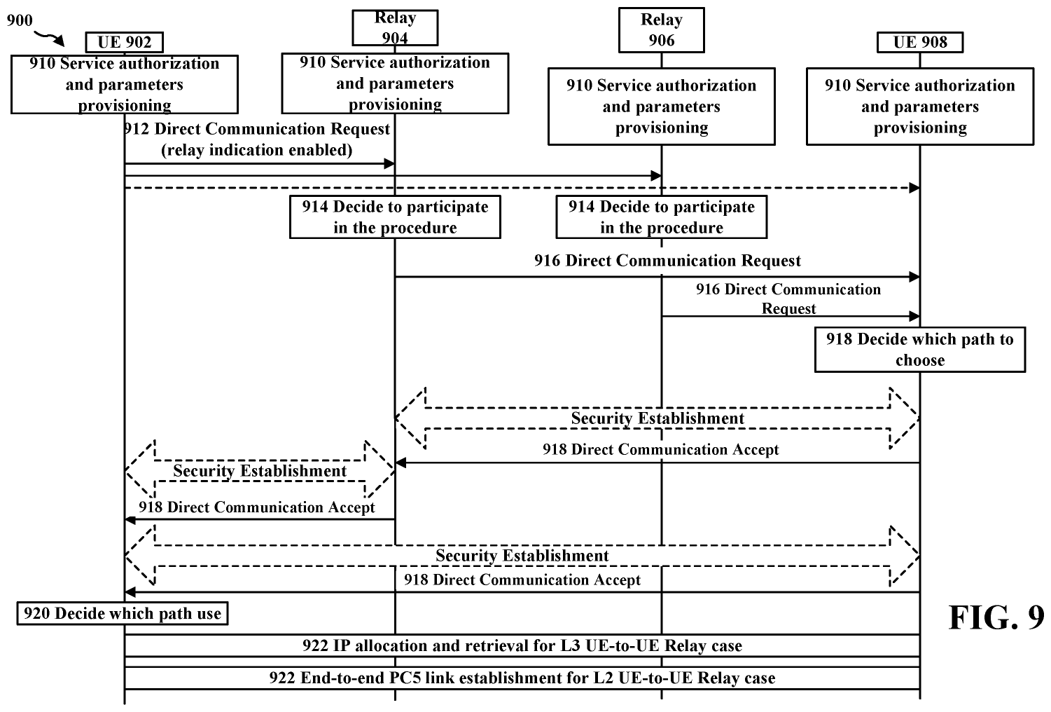

FIG. 9 is a diagram 900 illustrating communications between UEs for U2U relay. At 910, a source UE 902, a relay UE 904, a relay UE 906, and a UE 908 may perform service authorization and parameters provisioning for relaying. The UE 902 may transmit direct communication request 912 (e.g., with relay indication enabled) to the relay UE 904, the relay UE 906, and the UE 908. In some aspects, at 914, each of the relay UEs 904 and 906 may decide whether to participate in the relay procedure for communications between the UE 902 and the UE 908 at 914. If the relay UEs 904 and 906 decide to participate in the relay procedure for communications between the UE 902 and the UE 908 at 914 may communicate a direct communication request 916 to the UE 908. At 918, the UE 908 may decide which path (which of the relay UE 904 and the relay UE 906) to choose. Upon choosing the path, the UE 908 may perform security establishment with the chosen relay UE of the relay UE 904 and the relay UE 906 and then transmit a direction communication accept 918 to the chosen relay UE of the relay UE 904. In some aspects, upon receiving the direction communication accept 918, the chosen relay UE of the relay UE 904 and the relay UE 906 may perform security establishment with the UE 902 and transmit the direction communication accept 918 to the UE 902. Then security establishment between the UE 902, the chosen relay UE of the relay UE 904 and the relay UE 906, and the UE 908, may be performed. The UE 902 may decide on a path to choose at 920 and IP allocation and retrieval (for L3 UE to UE relay) or end to end sidelink establishment (for L2 UE to UE relay) may be performed at 922.

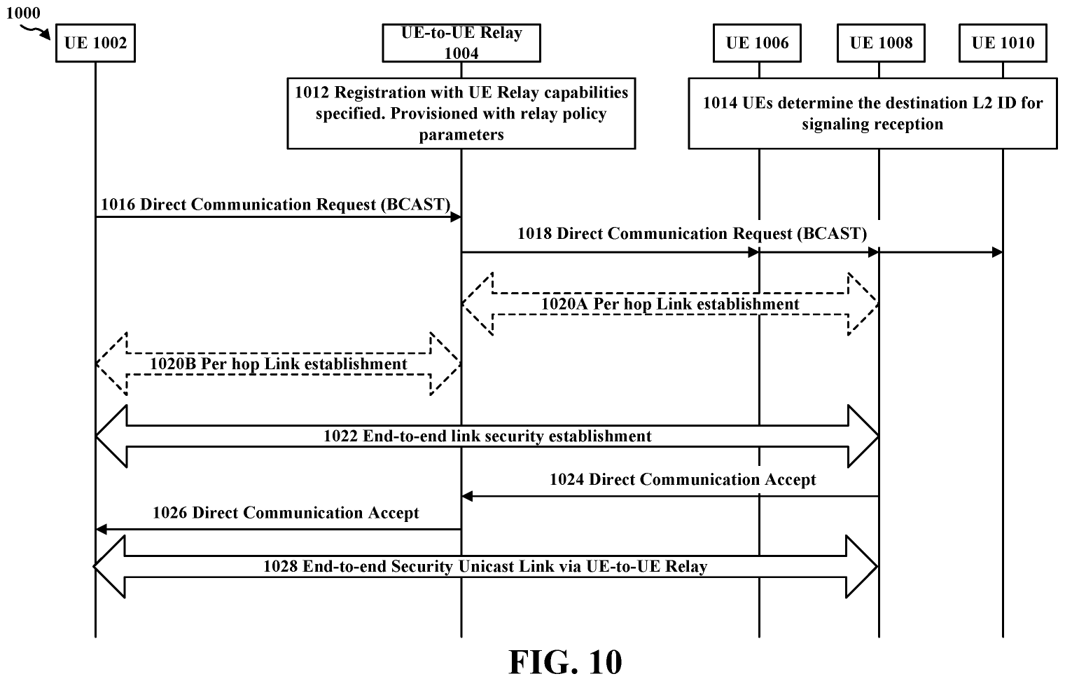

FIG. 10 is a diagram 1000 illustrating communications between UEs for U2U relay. As illustrated in FIG. 10, at 1012, the UE-to-UE relay 1004 (relay UE 1004) may perform registration with UE Relay capabilities specified. The relay UE 1004 may be provisioned with relay policy parameters. One or more UEs 1006, 1008, and 1010 may determine the destination L2 ID for signaling reception at 1014. In some aspects, the UE 1002 may transmit a direct communication request 1016 to the relay UE 1004 via broadcast or groupcast. Upon receiving the direct communication request 1016, the relay UE 1004 may in turn transmit the direct communication request 1018 based on the direct communication request 1016 to the one or more UEs 1006, 1008, and 1010 via broadcast or groupcast. At 1020A, per hop link establishment may be performed between the relay UE 1004 and a subset of the one or more UEs 1006, 1008, and 1010. At 1020B, per hop link establishment may be performed between the relay UE 1004 and the UE 1002. After performing the per hop link establishment at 1020A and 1020B, end to end link security establishment may be performed at 1022. In some aspects, the subset of the one or more UEs 1006, 1008, and 1010 may transmit a direct communication accept 1024 to the relay UE 1004 which may in turn transmit the direct communication accept 1024 in direct communication accept 1026 to the UE 1002. Upon receiving the direct communication accept 1026, the UE 1002, the relay UE 1004, and the subset of the one or more UEs 1006, 1008, and 1010 may establish an end to end security unicast link via U2U relay at 1028.

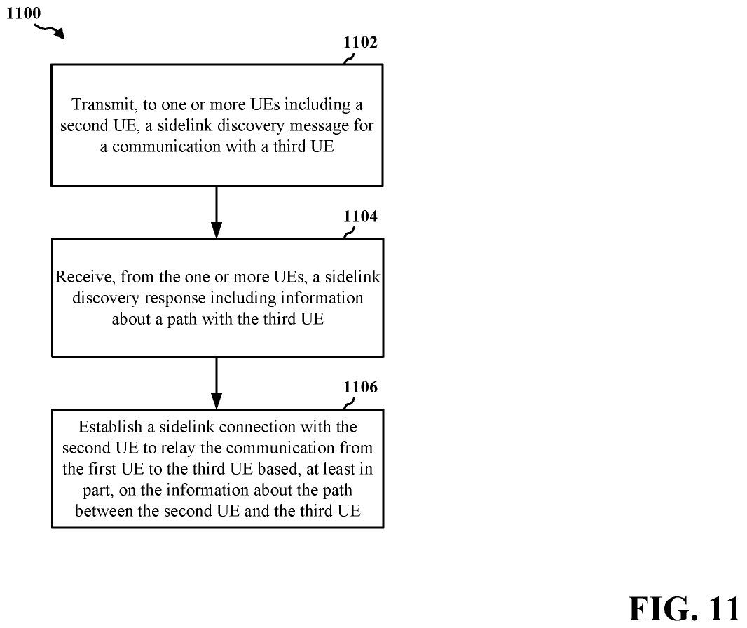

FIG. 11 is a flowchart 1100 of a method of wireless communication. The method may be performed by a source UE (e.g., the UE 104, the UE 602, the UE 802, other UEs; the apparatus 1502). The method may improve the selection of a relay UE for U2U communication through the consideration of metrics regarding a path between the relay UE and the destination UE.

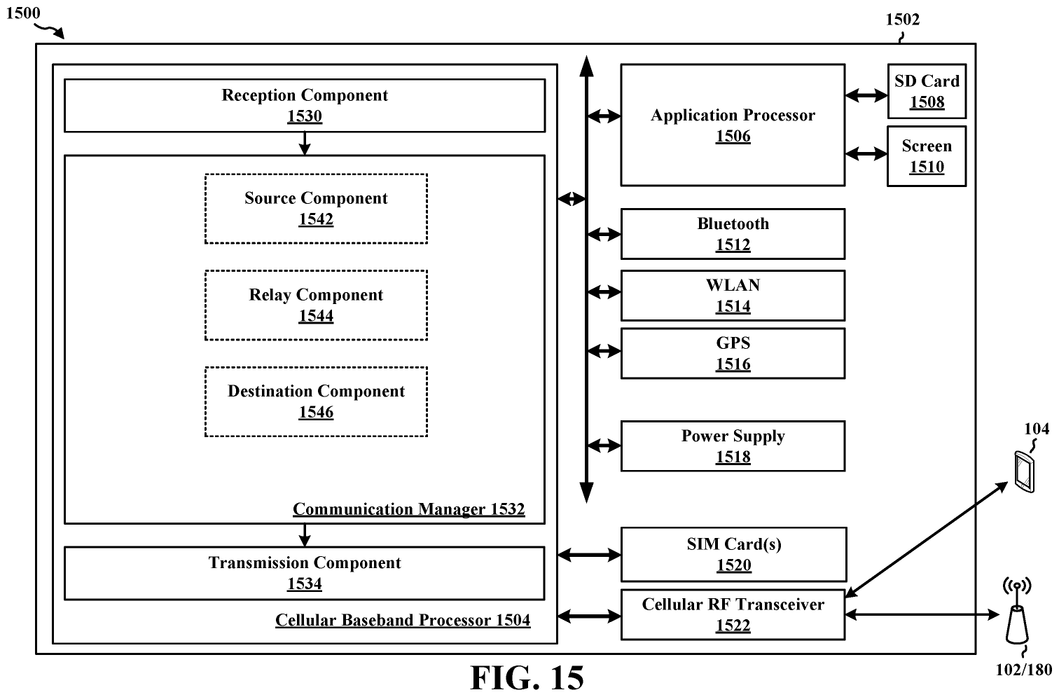

At 1102, the UE may transmit, to one or more UEs including a second UE, a sidelink discovery message for a communication with a third UE. For example, the UE 602 or the UE 802 may transmit, to one or more UEs 604 or 804 including a second UE, a sidelink discovery message (e.g., solicitation 608 or relay discovery 808/announce 814) for a communication with a third UE 606 or 806. In some aspects, 1102 may be performed by source component 1542 in FIG. 15. In some aspects, the sidelink discovery message includes a solicitation message that includes a RSC, source UE information associated with the first UE, destination UE information associated with the third UE, and a set of cost metrics associated with relay UE selection, the set of cost metrics including at least one of a hop count or one or more link quality metrics. In some aspects, the sidelink discovery message includes a broadcast or a groupcast to a destination L2 identifier for user-to-user relay discovery or a unicast to the one or more UEs, the one or more UEs being associated with a SD-RSRP higher than a threshold.

At 1104, the UE may receive, from the one or more UEs, a sidelink discovery response including information about a path with the third UE. For example, the UE 602 or the UE 802 may receive, from the one or more UEs 604 or 804, a sidelink discovery response (e.g., the solicitation response 616/620 or announce 818) including information about a path with the third UE. In some aspects, 1104 may be performed by source component 1542 in FIG. 15. In some aspects, the sidelink discovery response from each of the one or more UEs includes a solicitation response message that includes the RSC, one or more cost metric measurements, the destination UE information associated with the third UE, and a set of link path indications representing one or more links with the third UE. In some aspects, the information about the path with the third UE includes one or more cost metric measurements that include one or more link quality metrics that are based on one or more of: a S-RSRP of an upstream neighbor UE, a SL-RSRP of the upstream neighbor UE, or a CBR. In some aspects, the UE may select the second UE based on the one or more link quality metrics being higher than a threshold. In some aspects, the sidelink discovery response includes a hop count that is incremented based on a number of hops between the first UE and the third UE. In some aspects, the UE may select the second UE based on a minimum hop count. In some aspects, the sidelink connection with the second UE is for first communication from the first UE to the third UE via the second UE. In some aspects, the UE may establish a second connection with a fourth UE (e.g., another relay UE) for second communication from the third UE to the first UE via the fourth UE. In some aspects, the sidelink discovery message includes a discovery announcement message for support of user-to-user relaying and reachability, the sidelink discovery message including UE information associated with the first UE or the third UE and a set of cost metrics, the set of cost metrics including at least one of a hop count or one or more link quality metrics, and where the sidelink discovery response includes a relay UE discovery announcement message including a RSC and UE information associated with the one or more reachable UEs including the third UE. In some aspects, the UE may transmit to the second UE, a solicitation message for the communication with the third UE. In some aspects, the discovery announcement message is periodic and based on one or more SD-RSRP or one or more SL-RSRP.

At 1106, the UE may establish a sidelink connection with the second UE to relay the communication from the first UE to the third UE based, at least in part, on the information about the path between the second UE and the third UE. For example, the UE 602 or the UE 802 may establish a sidelink connection with the second UE (e.g., a UE 804 or a UE 604) to relay the communication from the first UE to the third UE based, at least in part, on the information about the path between the second UE and the third UE. In some aspects, 1106 may be performed by source component 1542 in FIG. 15.

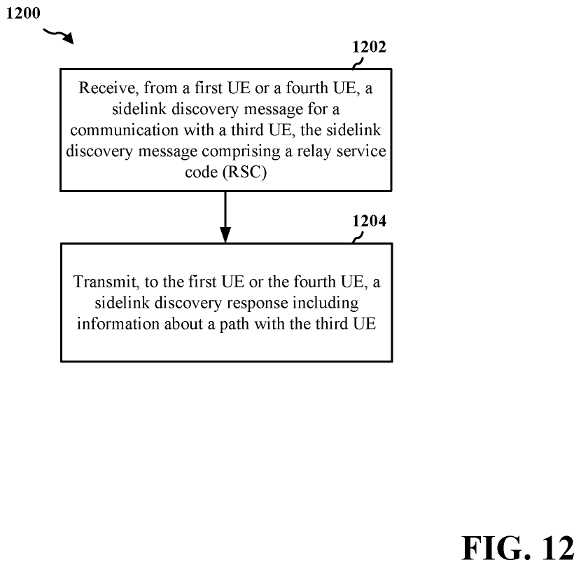

FIG. 12 is a flowchart 1200 of a method of wireless communication. The method may be performed by a relay UE (e.g., the UE 104, the UE 604, other UEs; the apparatus 1502). The method may improve the selection of a relay UE for U2U communication through information that enables the consideration of metrics regarding a path between the relay UE and the destination UE in connection with relay UE selection.

At 1202, the UE may receive, from a first UE or a fourth UE, a sidelink discovery message for a communication with a third UE, the sidelink discovery message including a RSC. For example, the UE 604 may receive, from a first UE 602 or a fourth UE in the one or more UEs 604, a sidelink discovery message (e.g., solicitation 608) for a communication with a third UE, the sidelink discovery message including a RSC. In some aspects, 1202 may be performed by relay component 1544 in FIG. 15. In some aspects, the sidelink discovery message includes a solicitation message for the communication with the third UE, the solicitation message including, in addition to the RSC, source UE information associated with the first UE, destination UE information associated with the third UE, and a set of cost metrics associated with selecting the second UE, the set of cost metrics including at least one of a hop count or one or more link quality metrics. In some aspects, the solicitation message is received via broadcast or groupcast to a destination L2 identifier for user-to-user relay discovery or unicast to the second UE, the second UE being associated with a SD-RSRP higher than a threshold. In some aspects, the one or more link quality metrics are based on one or more of: a SD-RSRP of an upstream neighbor UE, a SL-RSRP of the upstream neighbor UE, or a CBR, where the upstream neighbor UE is the fourth UE or the fifth UE. In some aspects, the UE may increment the hop count upon receiving the solicitation message or the solicitation response message. In some aspects, the UE may add a UE ID associated with the second UE to a list associated with the set of cost metrics. In some aspects, the UE may aggregate the set of cost metrics based on the set of cost metrics and one or more measurements.

In some aspects, the UE may transmit, to the third UE or a fifth UE (e.g., another relay UE 604), the solicitation message. In some aspects, the UE may receive, from the third UE or the fifth UE, a solicitation response message originated from the third UE and including the RSC, the set of cost metrics, the destination UE information associated with the third UE, and a set of link path indications representing one or more links between the first UE and the third UE. In some aspects, the UE may establish a first connection with a set of UEs associated with the one or more links including the first UE and the third UE to facilitate the communication with the third UE.

At 1204, the UE may transmit, to the first UE or the fourth UE, a sidelink discovery response including information about a path with the third UE. For example, the UE 604 may transmit, to the first UE 602 or the fourth UE in the one or more UEs 604, a sidelink discovery response (e.g., solicitation response) including information about a path with the third UE. In some aspects, 1204 may be performed by relay component 1544 in FIG. 15.

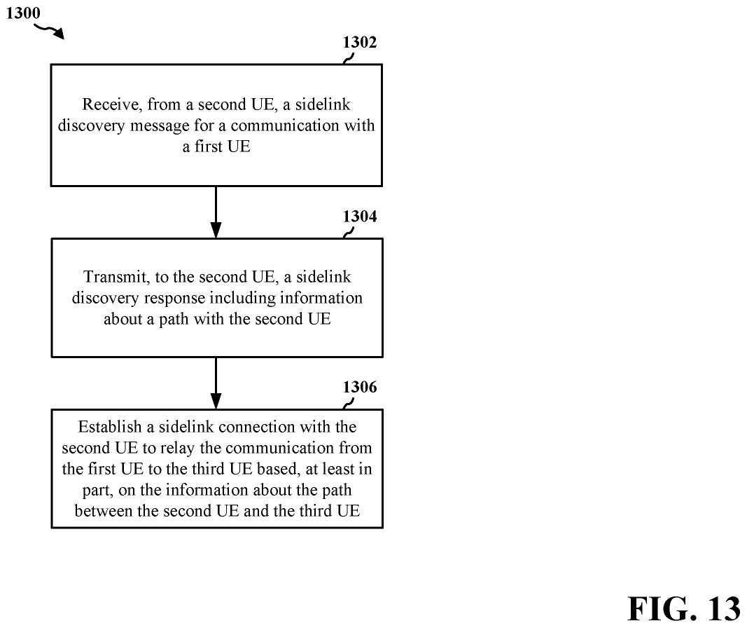

FIG. 13 is a flowchart 1300 of a method of wireless communication. The method may be performed by a destination UE (e.g., the UE 104, the UE 606, the UE 806, other UEs; the apparatus 1502). The method may improve the selection of a relay UE for U2U communication through information that enables the consideration of metrics regarding a path between the relay UE and the destination UE in connection with relay UE selection.

At 1302, the UE may receive, from a second UE, a sidelink discovery message for a communication with a first UE. For example, the UE 606 or the UE 806 may receive, from a second UE, a sidelink discovery message for a communication with a first UE. In some aspects, 1302 may be performed by destination component 1546 in FIG. 15. In some aspects, the sidelink discovery message is received from broadcast or groupcast to a destination L2 identifier for user-to-user relay discovery or unicast, the unicast being based on a SD-RSRP higher than a threshold.

At 1304, the UE may transmit, to the second UE, a sidelink discovery response including information about a path with the second UE. For example, the UE 606 or the UE 806 may transmit, to the second UE, a sidelink discovery response including information about a path with the second UE. In some aspects, 1304 may be performed by destination component 1546 in FIG. 15. In some aspects, the information about the path with the third UE includes one or more cost metric measurements that include one or more link quality metrics based on one or more of: a SD-RSRP of an upstream neighbor UE, a SL-RSRP of the upstream neighbor UE, or a CBR. In some aspects, the UE may select the second UE based on the one or more link quality metrics being higher than a threshold. In some aspects, the sidelink discovery response includes a hop count that is incremented based on a number of hops between the first UE and the third UE. In some aspects, the UE may select the second UE based on a minimum hop count.

At 1306, the UE may establish a sidelink connection with the second UE to relay the communication from the first UE to the third UE based, at least in part, on the information about the path between the second UE and the third UE. For example, the UE 606 or the UE 806 may establish a sidelink connection with the second UE to relay the communication from the first UE to the third UE based, at least in part, on the information about the path between the second UE and the third UE. In some aspects, 1306 may be performed by destination component 1546 in FIG. 15. In some aspects, the first connection is for first from the first UE to the third UE via the second UE. In some aspects, the UE may establish a second connection with a fourth UE for second communication from the third UE to the first UE via the fourth UE.

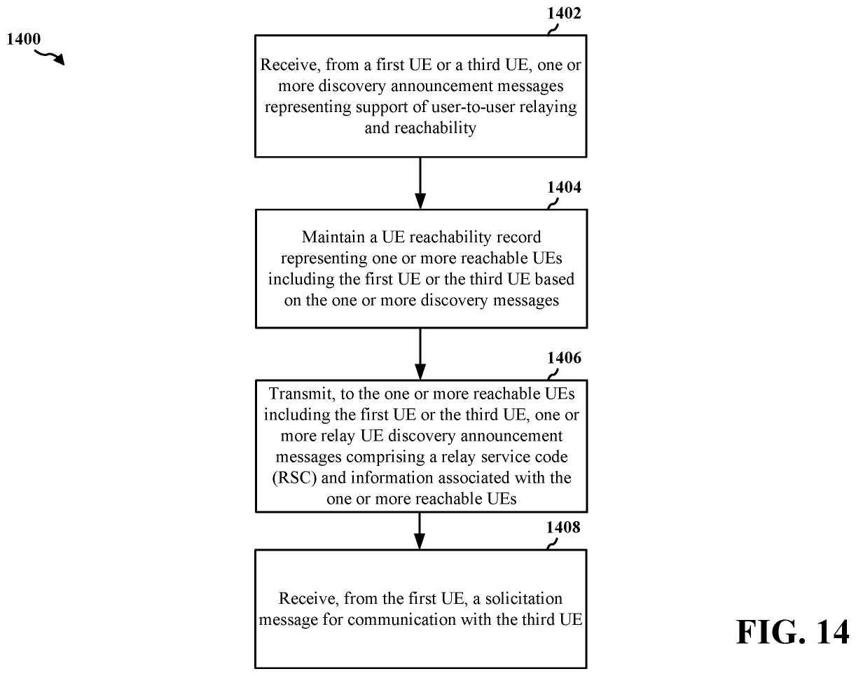

FIG. 14 is a flowchart 1400 of a method of wireless communication. The method may be performed by a relay UE (e.g., the UE 104, the UE 804, other UEs; the apparatus 1502). The method may improve the selection of a relay UE for U2U communication through information that enables the consideration of metrics regarding a path between the relay UE and the destination UE in connection with relay UE selection.

At 1402, the UE may receive, from a first UE or a third UE, one or more discovery announcement messages representing support of user-to-user relaying and reachability, the discovery message including UE information associated with the first UE or the third UE and a set of cost metrics, the set of cost metrics including at least one of a hop count or one or more link quality metrics. For example, the UE 804 may receive, from a first UE 802 or a third UE 806, one or more discovery announcement messages (e.g., 812/814) representing support of user-to-user relaying and reachability. In some aspects, 1402 may be performed by relay component 1544 in FIG. 15. In some aspects, the one or more discovery announcement messages are periodic and based on one or more SD-RSRP or one or more SL-RSRP. In some aspects, the communication is for at least one of first communication from the first UE to the third UE via the second UE or second communication from the third UE to the first UE via the second UE.

At 1404, the UE may maintain a UE reachability record representing one or more reachable UEs including the first UE or the third UE based on the one or more discovery messages. For example, the UE 804 may maintain a UE reachability record representing one or more reachable UEs including the first UE 802 or the third UE 806 based on the one or more discovery messages at 816. In some aspects, 1404 may be performed by relay component 1544 in FIG. 15.

At 1406, the UE may transmit, to the one or more reachable UEs including the first UE or the third UE, one or more relay UE discovery announcement messages including a RSC and information associated with the one or more reachable UEs. For example, the UE 804 may transmit, to the one or more reachable UEs including the first UE 802 or the third UE 806, one or more relay UE discovery announcement messages (e.g., 818) including a RSC and information associated with the one or more reachable UEs. In some aspects, 1406 may be performed by relay component 1544 in FIG. 15.

At 1408, the UE may receive, from the first UE, a solicitation message for communication with the third UE. For example, the UE 804 may receive, from the first UE 802, a solicitation message 820 for communication with the third UE. In some aspects, 1408 may be performed by relay component 1544 in FIG. 15.

FIG. 15 is a diagram 1500 illustrating an example of a hardware implementation for an apparatus 1502. The apparatus 1502 may be a UE, a component of a UE, or may implement UE functionality. In some aspects, the apparatus 1502 may include a cellular baseband processor 1504 (also referred to as a modem) coupled to a cellular RF transceiver 1522. In some aspects, the apparatus 1502 may further include one or more subscriber identity modules (SIM) cards 1520, an application processor 1506 coupled to a secure digital (SD) card 1508 and a screen 1510, a Bluetooth module 1512, a wireless local area network (WLAN) module 1514, a Global Positioning System (GPS) module 1516, or a power supply 1518. The cellular baseband processor 1504 communicates through the cellular RF transceiver 1522 with the UE 104 and/or BS 102/180. The cellular baseband processor 1504 may include a computer-readable medium/memory. The computer-readable medium/memory may be non-transitory. The cellular baseband processor 1504 is responsible for general processing, including the execution of software stored on the computer-readable medium/memory. The software, when executed by the cellular baseband processor 1504, causes the cellular baseband processor 1504 to perform the various functions described supra. The computer-readable medium/memory may also be used for storing data that is manipulated by the cellular baseband processor 1504 when executing software. The cellular baseband processor 1504 further includes a reception component 1530, a communication manager 1532, and a transmission component 1534. The communication manager 1532 includes the one or more illustrated components. The components within the communication manager 1532 may be stored in the computer-readable medium/memory and/or configured as hardware within the cellular baseband processor 1504. The cellular baseband processor 1504 may be a component of the UE 350 and may include the memory 360 and/or at least one of the TX processor 368, the RX processor 356, and the controller/processor 359. In one configuration, the apparatus 1502 may be a modem chip and include just the baseband processor 1504, and in another configuration, the apparatus 1502 may be the entire UE (e.g., see 350 of FIG. 3) and include the additional modules of the apparatus 1502.

The communication manager 1532 may include a source component 1542 that is configured to transmit, to one or more UEs including a second UE, a sidelink discovery message for a communication with a third UE, receive, from the one or more UEs, a sidelink discovery response including information about a path with the third UE, establish a sidelink connection with the second UE to relay the communication from the first UE to the third UE based, at least in part, on the information about the path between the second UE and the third UE, e.g., as described in connection with FIG. 11.

The communication manager 1532 may further include a relay component 1544 that may be configured to Receive, from a first UE or a fourth UE, a sidelink discovery message for a communication with a third UE, the sidelink discovery message including a RSC, transmit, to the first UE or the fourth UE, a sidelink discovery response including information about a path with the third UE, e.g., as described in connection with FIG. 12.

In some aspects, the relay component 1544 may be configured to receive, from the first UE, a solicitation message for communication with the third UE, transmit, to the one or more reachable UEs including the first UE or the third UE, one or more relay UE discovery announcement messages including a RSC and information associated with the one or more reachable UEs, maintain a UE reachability record representing one or more reachable UEs including the first UE or the third UE based on the one or more discovery messages, receive, from a first UE or a third UE, one or more discovery announcement messages representing support of user-to-user relaying and reachability, e.g., as described in connection with FIG. 14.

The communication manager 1532 may further include a destination component 1546 that may be configured to receive, from a second UE, a sidelink discovery message for a communication with a first UE, transmit, to the second UE, a sidelink discovery response including information about a path with the second UE, establish a sidelink connection with the second UE to relay the communication from the first UE to the third UE based, at least in part, on the information about the path between the second UE and the third UE, e.g., as described in connection with FIG. 13.

The apparatus may include additional components that perform each of the blocks of the algorithm in the flowcharts of FIGS. 11-14. As such, each block in the flowcharts of FIGS. 11-14 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1502 may include a variety of components configured for various functions. In one configuration, the apparatus 1502, and in particular the cellular baseband processor 1504, may include means for transmitting, to one or more UEs including a second UE, a sidelink discovery message for a communication with a third UE. The cellular baseband processor 1504 may further include means for receiving, from the one or more UEs, a sidelink discovery response including information about a path with the third UE. The cellular baseband processor 1504 may further include means for establishing a sidelink connection with the second UE to relay the communication from the first UE to the third UE based, at least in part, on the information about the path between the second UE and the third UE. The cellular baseband processor 1504 may further include means for receiving, from a first UE or a fourth UE, a sidelink discovery message for a communication with a third UE, the sidelink discovery message including a RSC. The cellular baseband processor 1504 may further include means for transmitting, to the first UE or the fourth UE, a sidelink discovery response including information about a path with the third UE. The cellular baseband processor 1504 may further include means for receiving, from a second UE, a sidelink discovery message for a communication with a first UE. The cellular baseband processor 1504 may further include means for transmitting, to the second UE, a sidelink discovery response including information about a path with the second UE. The cellular baseband processor 1504 may further include means for establishing a sidelink connection with the second UE to relay the communication from the first UE to the third UE based, at least in part, on the information about the path between the second UE and the third UE. The cellular baseband processor 1504 may further include means for receiving, from a first UE or a third UE, one or more discovery announcement messages representing support of user-to-user relaying and reachability, the discovery message including UE information associated with the first UE or the third UE and a set of cost metrics, the set of cost metrics including at least one of a hop count or one or more link quality metrics. The cellular baseband processor 1504 may further include means for maintaining a UE reachability record representing one or more reachable UEs including the first UE or the third UE based on the one or more discovery messages. The cellular baseband processor 1504 may further include means for transmitting, to the one or more reachable UEs including the first UE or the third UE, one or more relay UE discovery announcement messages including a RSC and information associated with the one or more reachable UEs. The cellular baseband processor 1504 may further include means for receiving, from the first UE, a solicitation message for communication with the third UE. The cellular baseband processor 1504 may further include means for selecting the second UE based on the one or more link quality metrics being higher than a threshold. The cellular baseband processor 1504 may further include means for selecting the second UE based on a minimum hop count. The cellular baseband processor 1504 may further include means for establishing a second connection with a fourth UE for second communication from the third UE to the first UE via the fourth UE. The cellular baseband processor 1504 may further include means for transmitting to the second UE, a solicitation message for the communication with the third UE. The cellular baseband processor 1504 may further include means for transmitting, to the third UE or a fifth UE, the solicitation message. The cellular baseband processor 1504 may further include means for receiving, from the third UE or the fifth UE, a solicitation response message originated from the third UE and including the RSC, the set of cost metrics, the destination UE information associated with the third UE, and a set of link path indications representing one or more links between the first UE and the third UE. The cellular baseband processor 1504 may further include means for establishing a first connection with a set of UEs associated with the one or more links including the first UE and the third UE to facilitate the communication with the third UE. The cellular baseband processor 1504 may further include means for incrementing the hop count upon receiving the solicitation message or the solicitation response message. The cellular baseband processor 1504 may further include means for adding a UE ID associated with the second UE to a list associated with the set of cost metrics. The cellular baseband processor 1504 may further include means for aggregating the set of cost metrics based on the set of cost metrics and one or more measurements. The means may be one or more of the components of the apparatus 1502 configured to perform the functions recited by the means. As described supra, the apparatus 1502 may include the TX Processor 368, the RX Processor 356, and the controller/processor 359. As such, in one configuration, the means may be the TX Processor 368, the RX Processor 356, and the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a first UE, comprising: a memory; and at least one processor coupled to the memory and configured to: transmit, to one or more UEs including a second UE, a sidelink discovery message for a communication with a third UE; receive, from the one or more UEs, a sidelink discovery response including information about a path with the third UE; and establish a sidelink connection with the second UE to relay the communication from the first UE to the third UE based, at least in part, on the information about the path between the second UE and the third UE.

Aspect 2 is the apparatus of aspect 1, further comprising: at least one transceiver coupled to the at least one processor, wherein the sidelink discovery message comprises a solicitation message that includes a RSC, source UE information associated with the first UE, destination UE information associated with the third UE, and a set of cost metrics associated with relay UE selection, the set of cost metrics comprising at least one of a hop count or one or more link quality metrics, and wherein the sidelink discovery response from each of the one or more UEs comprises a solicitation response message that includes the RSC, one or more cost metric measurements, the destination UE information associated with the third UE, and a set of link path indications representing one or more links with the third UE.

Aspect 3 is the apparatus of any of aspects 1-2, wherein the sidelink discovery message comprises a broadcast or a groupcast to a destination L2 identifier for user-to-user relay discovery or a unicast to the one or more UEs, the one or more UEs being associated with a SD-RSRP higher than a threshold.

Aspect 4 is the apparatus of any of aspects 1-3, wherein the information about the path with the third UE comprises one or more cost metric measurements that include one or more link quality metrics that are based on one or more of: a SD-RSRP of an upstream neighbor UE, a SL-RSRP of the upstream neighbor UE, or a CBR.

Aspect 5 is the apparatus of any of aspects 1-4, wherein the at least one processor is further configured to: select the second UE based on the one or more link quality metrics being higher than a threshold.

Aspect 6 is the apparatus of any of aspects 1-5, wherein the sidelink discovery response includes a hop count that is incremented based on a number of hops between the first UE and the third UE.

Aspect 7 is the apparatus of any of aspects 1-6, wherein the at least one processor is further configured to: select the second UE based on a minimum hop count.

Aspect 8 is the apparatus of any of aspects 1-7, wherein the sidelink connection with the second UE is for first communication from the first UE to the third UE via the second UE, wherein the at least one processor is further configured to: establish a second connection with a fourth UE for second communication from the third UE to the first UE via the fourth UE.

Aspect 9 is the apparatus of any of aspects 1-8, wherein the sidelink discovery message comprises a discovery announcement message for support of user-to-user relaying and reachability, the sidelink discovery message comprising UE information associated with the first UE or the third UE and a set of cost metrics, the set of cost metrics comprising at least one of a hop count or one or more link quality metrics, and wherein the sidelink discovery response comprises a relay UE discovery announcement message comprising a RSC and UE information associated with the one or more reachable UEs including the third UE, wherein the at least one processor is further configured to: transmit to the second UE, a solicitation message for the communication with the third UE.

Aspect 10 is the apparatus of any of aspects 1-9, wherein the discovery announcement message is periodic and based on one or more SD-RSRP or one or more SL-RSRP.

Aspect 11 is an apparatus for wireless communication at a second UE, comprising: a memory; and at least one processor coupled to the memory and configured to: receive, from a first UE or a fourth UE, a sidelink discovery message for a communication with a third UE, the sidelink discovery message comprising a RSC; and transmit, to the first UE or the fourth UE, a sidelink discovery response including information about a path with the third UE.

Aspect 12 is the apparatus of aspect 11, wherein the sidelink discovery message comprises a solicitation message for the communication with the third UE, the solicitation message comprising, in addition to the RSC, source UE information associated with the first UE, destination UE information associated with the third UE, and a set of cost metrics associated with selecting the second UE, the set of cost metrics comprising at least one of a hop count or one or more link quality metrics.

Aspect 13 is the apparatus of any of aspects 11-12, further comprising: at least one transceiver coupled to the at least one processor, wherein the at least one processor is further configured to: transmit, to the third UE or a fifth UE, the solicitation message; receive, from the third UE or the fifth UE, a solicitation response message originated from the third UE and comprising the RSC, the set of cost metrics, the destination UE information associated with the third UE, and a set of link path indications representing one or more links between the first UE and the third UE; and establish a first connection with a set of UEs associated with the one or more links including the first UE and the third UE to facilitate the communication with the third UE.

Aspect 14 is the apparatus of any of aspects 11-13, wherein the solicitation message is received via broadcast or groupcast to a destination L2 identifier for user-to-user relay discovery or unicast to the second UE, the second UE being associated with a SD-RSRP higher than a threshold.

Aspect 15 is the apparatus of any of aspects 11-14, wherein the one or more link quality metrics are based on one or more of: a SD-RSRP of an upstream neighbor UE, a SL-RSRP of the upstream neighbor UE, or a CBR, wherein the upstream neighbor UE is the fourth UE or the fifth UE.

Aspect 16 is the apparatus of any of aspects 11-15, wherein the at least one processor is further configured to: increment the hop count upon receiving the solicitation message or the solicitation response message.

Aspect 17 is the apparatus of any of aspects 11-16, wherein the at least one processor is further configured to: add a UE ID associated with the second UE to a list associated with the set of cost metrics.

Aspect 18 is the apparatus of any of aspects 11-17, wherein the at least one processor is further configured to: aggregate the set of cost metrics based on the set of cost metrics and one or more measurements.

Aspect 19 is the apparatus of any of aspects 11-18, wherein the set of UEs include the fourth UE and a fifth UE.

Aspect 20 is an apparatus for wireless communication at a third UE, comprising: a memory; and at least one processor coupled to the memory and configured to: receive, from a second UE, a sidelink discovery message for a communication with a first UE; transmit, to the second UE, a sidelink discovery response including information about a path with the second UE; and establish a sidelink connection with the second UE to relay the communication from the first UE to the third UE based, at least in part, on the information about the path between the second UE and the third UE.

Aspect 21 is the apparatus of aspect 20, further comprising: at least one transceiver coupled to the at least one processor, wherein the sidelink discovery message is received from broadcast or groupcast to a destination L2 identifier for user-to-user relay discovery or unicast, the unicast being based on a SD-RSRP higher than a threshold.

Aspect 22 is the apparatus of any of aspects 20-21, wherein the information about the path with the third UE comprises one or more cost metric measurements that include one or more link quality metrics based on one or more of: a SD-RSRP of an upstream neighbor UE, a SL-RSRP of the upstream neighbor UE, or a CBR.

Aspect 23 is the apparatus of any of aspects 20-22, wherein the at least one processor is further configured to: select the second UE based on the one or more link quality metrics being higher than a threshold.

Aspect 24 is the apparatus of any of aspects 20-23, wherein the sidelink discovery response includes a hop count that is incremented based on a number of hops between the first UE and the third UE.

Aspect 25 is the apparatus of any of aspects 20-24, wherein the at least one processor is further configured to: select the second UE based on a minimum hop count.

Aspect 26 is the apparatus of any of aspects 20-25, wherein the first connection is for first from the first UE to the third UE via the second UE, and wherein the at least one processor is further configured to: establish a second connection with a fourth UE for second communication from the third UE to the first UE via the fourth UE.

Aspect 27 is an apparatus for wireless communication at a second UE, comprising: a memory; and at least one processor coupled to the memory and configured to: receive, from a first UE or a third UE, one or more discovery announcement messages representing support of user-to-user relaying and reachability, the discovery message comprising UE information associated with the first UE or the third UE and a set of cost metrics, the set of cost metrics comprising at least one of a hop count or one or more link quality metrics; maintain a UE reachability record representing one or more reachable UEs including the first UE or the third UE based on the one or more discovery messages; transmit, to the one or more reachable UEs including the first UE or the third UE, one or more relay UE discovery announcement messages comprising a RSC and information associated with the one or more reachable UEs; and receive, from the first UE, a solicitation message for communication with the third UE.

Aspect 28 is the apparatus of aspect 27, wherein the one or more discovery announcement messages are periodic and based on one or more SD-RSRP or one or more SL-RSRP.

Aspect 29 is the apparatus of any of aspects 27-28, wherein the communication is for at least one of: first communication from the first UE to the third UE via the second UE, or second communication from the third UE to the first UE via the second UE.

Aspect 30 is the apparatus of any of aspects 27-29, further comprising a transceiver coupled to the at least one processor.

Aspect 31 is a method of wireless communication for implementing any of aspects 1 to 10.

Aspect 32 is an apparatus for wireless communication including means for implementing any of aspects 1 to 10.

Aspect 33 is a computer-readable medium storing computer executable code, where the code when executed by a processor causes the processor to implement any of aspects 1 to 10.

Aspect 34 is a method of wireless communication for implementing any of aspects 11 to 19.

Aspect 35 is an apparatus for wireless communication including means for implementing any of aspects 11 to 19.

Aspect 36 is a computer-readable medium storing computer executable code, where the code when executed by a processor causes the processor to implement any of aspects 11 to 19.

Aspect 37 is a method of wireless communication for implementing any of aspects 20 to 26.

Aspect 38 is an apparatus for wireless communication including means for implementing any of aspects 20 to 26.

Aspect 39 is a computer-readable medium storing computer executable code, where the code when executed by a processor causes the processor to implement any of aspects 20 to 26.

Aspect 40 is a method of wireless communication for implementing any of aspects 27 to 30.

Aspect 41 is an apparatus for wireless communication including means for implementing any of aspects 27 to 30.

Aspect 42 is a computer-readable medium storing computer executable code, where the code when executed by a processor causes the processor to implement any of aspects 27 to 30.

What is claimed is:

1. An apparatus for wireless communication at a first user equipment (UE), comprising:
a memory; and
at least one processor coupled to the memory and configured to:
transmit, to one or more UEs including a second UE, a sidelink discovery message for a communication with a third UE;
receive, from the one or more UEs, a sidelink discovery response including information about a path with the third UE; and
establish a sidelink connection with the second UE to relay the communication from the first UE to the third UE based, at least in part, on the information about the path between the second UE and the third UE.

2. The apparatus of claim 1, further comprising:
at least one transceiver coupled to the at least one processor, wherein the sidelink discovery message comprises a solicitation message that includes a relay service code (RSC), source UE information associated with the first UE, destination UE information associated with the third UE, and a set of cost metrics associated with relay UE selection, the set of cost metrics comprising at least one of a hop count or one or more link quality metrics, and
wherein the sidelink discovery response from each of the one or more UEs comprises a solicitation response message that includes the RSC, one or more cost metric measurements, the destination UE information associated with the third UE, and a set of link path indications representing one or more links with the third UE.

3. The apparatus of claim 1, wherein the sidelink discovery message comprises a broadcast or a groupcast to a destination layer 2 (L2) identifier for user-to-user relay discovery or a unicast to the one or more UEs, the one or more UEs being associated with a sidelink discovery reference signal received power (SD-RSRP) higher than a threshold.

4. The apparatus of claim 1, wherein the information about the path with the third UE comprises one or more cost metric measurements that include one or more link quality metrics that are based on one or more of: a sidelink discovery reference signal received power (SD-RSRP) of an upstream neighbor UE, a sidelink reference signal received power (SL-RSRP) of the upstream neighbor UE, or a channel busy ratio (CBR).

5. The apparatus of claim 4, wherein the at least one processor is further configured to:
select the second UE based on the one or more link quality metrics being higher than a threshold.

6. The apparatus of claim 1, wherein the sidelink discovery response includes a hop count that is incremented based on a number of hops between the first UE and the third UE.

7. The apparatus of claim 1, wherein the at least one processor is further configured to:
select the second UE based on a minimum hop count.

8. The apparatus of claim 1, wherein the sidelink connection with the second UE is for first communication from the first UE to the third UE via the second UE, wherein the at least one processor is further configured to:
establish a second connection with a fourth UE for second communication from the third UE to the first UE via the fourth UE.

9. The apparatus of claim 1, wherein the sidelink discovery message comprises a discovery announcement message for support of user-to-user relaying and reachability, the sidelink discovery message comprising UE information associated with the first UE or the third UE and a set of cost metrics, the set of cost metrics comprising at least one of a hop count or one or more link quality metrics, and wherein the sidelink discovery response comprises a relay UE discovery announcement message comprising a relay service code (RSC) and UE information associated with the one or more reachable UEs including the third UE, wherein the at least one processor is further configured to
transmit to the second UE, a solicitation message for the communication with the third UE.

10. The apparatus of claim 9, wherein the discovery announcement message is periodic and based on one or more sidelink discovery reference signal received power (SD-RSRP) or one or more sidelink reference signal received power (SL-RSRP).

11. An apparatus for wireless communication at a second user equipment (UE), comprising:
a memory; and
at least one processor coupled to the memory and configured to:
receive, from a first UE or a fourth UE, a sidelink discovery message for a communication with a third UE, the sidelink discovery message comprising a relay service code (RSC); and
transmit, to the first UE or the fourth UE, a sidelink discovery response including information about a path with the third UE.

12. The apparatus of claim 11, wherein the sidelink discovery message comprises a solicitation message for the communication with the third UE, the solicitation message comprising, in addition to the RSC, source UE information associated with the first UE, destination UE information associated with the third UE, and a set of cost metrics associated with selecting the second UE, the set of cost metrics comprising at least one of a hop count or one or more link quality metrics.

13. The apparatus of claim 12, further comprising:
at least one transceiver coupled to the at least one processor, wherein the at least one processor is further configured to:
transmit, to the third UE or a fifth UE, the solicitation message;
receive, from the third UE or the fifth UE, a solicitation response message originated from the third UE and comprising the RSC, the set of cost metrics, the destination UE information associated with the third UE, and a set of link path indications representing one or more links between the first UE and the third UE; and
establish a first connection with a set of UEs associated with the one or more links including the first UE and the third UE to facilitate the communication with the third UE.

14. The apparatus of claim 13, wherein the solicitation message is received via broadcast or groupcast to a destination layer 2 (L2) identifier for user-to-user relay discovery or unicast to the second UE, the second UE being associated with a sidelink discovery reference signal received power (SD-RSRP) higher than a threshold.

15. The apparatus of claim 13, wherein the one or more link quality metrics are based on one or more of: a sidelink discovery reference signal received power (SD-RSRP) of an upstream neighbor UE, a sidelink reference signal received power (SL-RSRP) of the upstream neighbor UE, or a channel busy ratio (CBR), wherein the upstream neighbor UE is the fourth UE or the fifth UE.

16. The apparatus of claim 13, wherein the at least one processor is further configured to:
increment the hop count upon receiving the solicitation message or the solicitation response message.

17. The apparatus of claim 12, wherein the at least one processor is further configured to:
add a UE identifier (ID) associated with the second UE to a list associated with the set of cost metrics.

18. The apparatus of claim 12, wherein the at least one processor is further configured to:
aggregate the set of cost metrics based on the set of cost metrics and one or more measurements.

19. The apparatus of claim 12, wherein the set of UEs include the fourth UE and a fifth UE.

20. An apparatus for wireless communication at a third user equipment (UE), comprising:
a memory; and
at least one processor coupled to the memory and configured to:
receive, from a second UE, a sidelink discovery message for a communication with a first UE;
transmit, to the second UE, a sidelink discovery response including information about a path with the second UE; and
establish a sidelink connection with the second UE to relay the communication from the first UE to the third UE based, at least in part, on the information about the path between the second UE and the third UE.

21. The apparatus of claim 20, further comprising:
at least one transceiver coupled to the at least one processor, wherein the sidelink discovery message is received from broadcast or groupcast to a destination layer 2 (L2) identifier for user-to-user relay discovery or unicast, the unicast being based on a sidelink discovery reference signal received power (SD-RSRP) higher than a threshold.

22. The apparatus of claim 20, wherein the information about the path with the third UE comprises one or more cost metric measurements that include one or more link quality metrics based on one or more of: a sidelink discovery reference signal received power (SD-RSRP) of an upstream neighbor UE, a sidelink reference signal received power (SL-RSRP) of the upstream neighbor UE, or a channel busy ratio (CBR).

23. The apparatus of claim 22, wherein the at least one processor is further configured to:
select the second UE based on the one or more link quality metrics being higher than a threshold.

24. The apparatus of claim 20, wherein the sidelink discovery response includes a hop count that is incremented based on a number of hops between the first UE and the third UE.

25. The apparatus of claim 24, wherein the at least one processor is further configured to:
select the second UE based on a minimum hop count.

26. The apparatus of claim 20, wherein the first connection is for first from the first UE to the third UE via the second UE, and wherein the at least one processor is further configured to:
establish a second connection with a fourth UE for second communication from the third UE to the first UE via the fourth UE.

27. An apparatus for wireless communication at a second user equipment (UE), comprising:
a memory; and
at least one processor coupled to the memory and configured to:
receive, from a first UE or a third UE, one or more discovery announcement messages representing support of user-to-user relaying and reachability, the discovery message comprising UE information associated with the first UE or the third UE and a set of cost metrics, the set of cost metrics comprising at least one of a hop count or one or more link quality metrics;
maintain a UE reachability record representing one or more reachable UEs including the first UE or the third UE based on the one or more discovery messages;
transmit, to the one or more reachable UEs including the first UE or the third UE, one or more relay UE discovery announcement messages comprising a relay service code (RSC) and information associated with the one or more reachable UEs; and
receive, from the first UE, a solicitation message for communication with the third UE.

28. The apparatus of claim 27, wherein the one or more discovery announcement messages are periodic and based on one or more sidelink discovery reference signal received power (SD-RSRP) or one or more sidelink reference signal received power (SL-RSRP).

29. The apparatus of claim 27, wherein the communication is for at least one of:
first communication from the first UE to the third UE via the second UE, or
second communication from the third UE to the first UE via the second UE.

30. The apparatus of claim 27, further comprising a transceiver coupled to the at least one processor.
